(19) United States
(12) Patent Application Publication
(10) Pub. No.: US 2024/0257216 A1
(43) Pub. Date: Aug. 1, 2024

(54) SYSTEM AND METHOD FOR DETERMINING CROSS-POLLINATION PRODUCT RECOMMENDATIONS

(71) Applicant: Walmart Apollo, LLC, Bentonville, AR (US)

(72) Inventors: Rahul Sridhar, Santa Clara, CA (US); Luyi Ma, San Jose, CA (US); Sinduja Subramaniam, San Jose, CA (US); Shiqin Cai, Mountain View, CA (US); Jianpeng Xu, Cupertino, CA (US); Nikhil Shripad Thakurdesai, Milpitas, CA (US); Evren Korpeoglu, San Jose, CA (US); Kannan Achan, Saratoga, CA (US)

(73) Assignee: Walmart Apollo, LLC, Bentonville, AR (US)

(21) Appl. No.: 18/427,118

(22) Filed: Jan. 30, 2024

Related U.S. Application Data
(60) Provisional application No. 63/442,152, filed on Jan. 31, 2023.

(51) Int. Cl. G06Q 30/0601; G06Q 30/0201

(52) U.S. Cl. CPC G06Q 30/0631; G06Q 30/0201; G06Q 30/0625

(57) ABSTRACT

A computer-implemented method including determining an anchor product type for an anchor item. The method further can include determining at least one associated product type for the anchor product type. Determining the at least one associated product type for the anchor product type further can include: (a) determining at least one complementary product type for the anchor product type; (b) determining an anchor-product-type-name vector for an anchor-product-type name of the anchor product type; (c) determining a respective complementary-product-type-name vector for a respective complementary-product-type name of each of the at least one complementary product type; (d) determining a respective product-type-name similarity score between the anchor-product-type-name vector and the respective complementary-product-type-name vector for each of the at least one complementary product type; and (e) determining the at least one associated product type based at least in part on a product-type-level threshold and the respective product-type-name similarity score for each of the at least one complementary product type. The method also can include determining at least one associated item for the anchor item based at least in part on the at least one associated product type and at least one recommended item for the anchor item. The method further can include transmitting, via a computer network, the at least one associated item to be displayed on a user interface for a user. Other embodiments are described.

### CROSS-REFERENCE TO RELATED APPLICATIONS

This application claims the benefit of U.S. Provisional Application No. 63/442,152, filed Jan. 31, 2023. U.S. Patent Application No. 63/442,152 is incorporated herein by reference in its entirety.

### TECHNICAL FIELD

This disclosure relates generally to determining cross-pollination product recommendations.

### BACKGROUND

Online retailers often offer items in multiple types of categories. For example, routine categories can include groceries and consumables. Non-routine categories can include appliances and accessories and other general merchandise. Certain users of online retailers purchase only in routine categories, while certain other users purchase only in non-routing categories. Such users are siloed into one or the other type of categories, and do not purchase across types of categories.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for determining cross-pollination recommendations for an anchor item, according to an embodiment; and

FIG. 4 illustrates a flow chart for a method of providing cross-pollination recommendations, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, ten seconds, thirty seconds, one minute, five minutes, ten minutes, etc.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

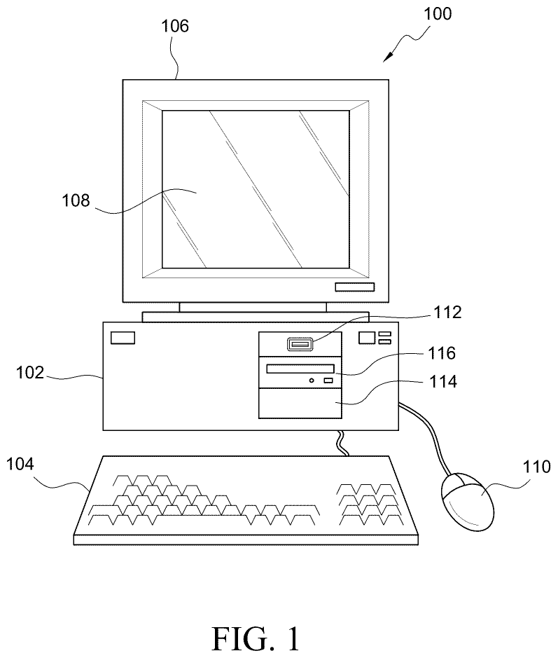

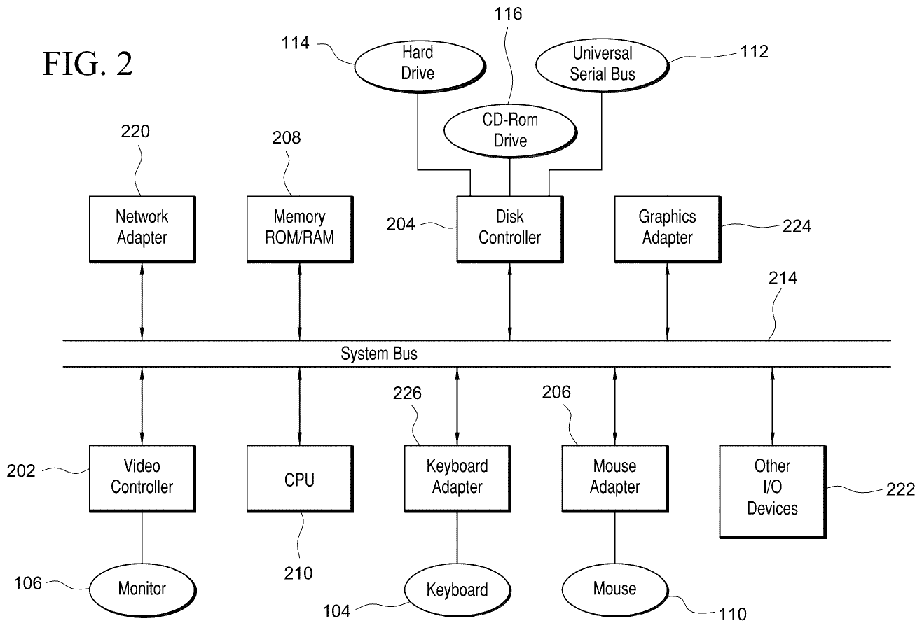

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

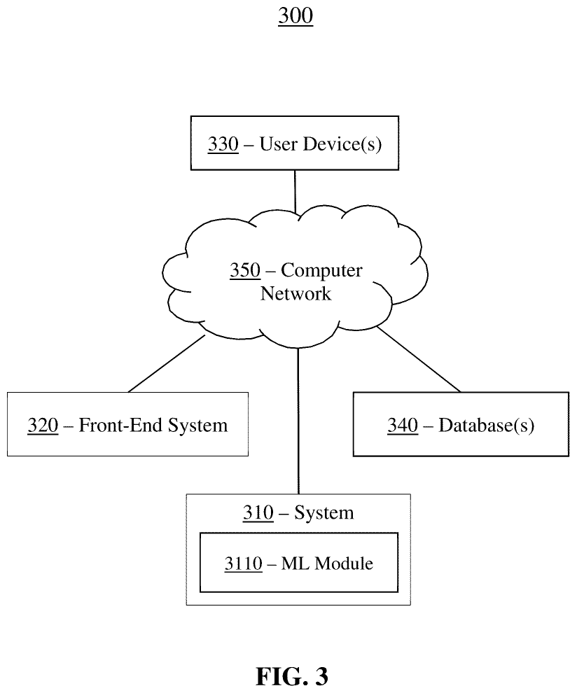

Turning ahead in the drawings, FIG. 3 illustrates a block diagram of a system 300 that can be employed for determining cross-pollination recommendations for an anchor item, according to an embodiment. In various embodiments, a cross-pollination (XP) recommendation for an anchor item can be a product recommendation for the anchor item that is from a product type the associated products for which are not routinely purchased, while the anchor item is associated to an anchor product type for products routinely purchased (e.g., replenished every week, 2 weeks, month, etc.). For example, when an anchor item is a bag of kitten food displayed on an online retailer webpage or a post-add-to-cart webpage, unlike conventional recommendations for similar items (e.g., cat food of another brand, or canned cat food, etc.), an XP recommendation can be a cat litter box, a cat tree tower, a dry food container, etc. In another example, when an anchor item is a box of brownie mix, an XP recommendation can be a brownie pan, a cake mold, etc. Providing cross-pollination recommendations instead of or in addition to conventional recommendations for similar or co-purchased items can provide more diverse and inspiring online shopping experience.

System 300 can provide cross-pollination (XP) recommendations by any suitable approaches. In many embodiments, system 300 can provide XP recommendations for an anchor item by (a) determining non-routine product types associated with an anchor product type (e.g., a routine product type) for the anchor item, based on any suitable product-type-level similarity methods or models; and (b) determining items in the non-routine product types, as determined, that are associated with the anchor item for the XP recommendations, based on any suitable item-level similarity methods or models.

System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein. In many embodiments, operators and/or administrators of system 300 can manage system 300, the processor(s) of system 300, and/or the memory storage unit(s) of system 300 using the input device(s) and/or display device(s) of system 300, or portions thereof in each case.

In many embodiments, system 300 can include a system 310, a front-end system 320, a user device(s) 330, and/or a database(s) 340. System 310 further can include one or more elements, modules, or systems, such as a machine learning module (ML module 3110) trained to perform various procedures, processes, and/or activities of system 300 and/or system 310.

System 310, front-end system 320, user device(s) 330, and/or ML module 3110 can each be a computer system, such as computer system 100 (FIG. 1), as described above, and can each be a single computer, a single server, or a cluster or collection of computers or servers, or a cloud of computers or servers. In another embodiment, a single computer system can host system 310, front-end system 320, user device(s) 330, and/or ML module 3110. Additional details regarding system 310, front-end system 320, user device(s) 330, and ML module 3110 are described herein.

In some embodiments, system 310 can be in data communication with front-end system 320 and/or user device(s) 330, using a computer network (e.g., computer network 350), such as the Internet and/or an internal network that is not open to the public. In a number of embodiments, front-end system 320 can host one or more websites and/or mobile application servers that interface with an application (e.g., a mobile application, a web browser, or a chat application) on a computer device (e.g., user device(s) 330) for a consumer or a vendor. In other examples, front-end system 320 further can support back-office applications, including receiving inputs from user device(s) 330, managing orders, item listings, inventory, and/or supply, and/or processing payments, etc.

Meanwhile, in many embodiments, system 310 also can be configured to communicate with and/or include a database(s) 340. In some embodiments, database(s) 340 can include a product catalog of a retailer that contains information about products, items, product types, vendors, or SKUs (stock keeping units), for example, among other data as described herein. In another example, database(s) 340 further can include training data (e.g., genuine items, labeled (positive) and unlabeled (positive or negative) training items that are synthesized or real, etc.) and/or hyper-parameters for training and/or configuring system 310 and/or ML module 3110. In yet another example, database(s) 340 also can include data associated with consumers, historical consumer transactions, and/or statistics or analysis performed for the historical consumer transactions.

In a number of embodiments, database(s) 340 can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more data sources, that particular database can be stored on a single memory storage unit or the contents of that particular database can be spread across multiple ones of the memory storage units storing the one or more databases, depending on the size of the particular database and/or the storage capacity of the memory storage units. In similar or different embodiments, the one or more data sources can each be a computer system, such as computer system 100 (FIG. 1), as described above, and can each be a single computer, a single server, or a cluster or collection of computers or servers, or a cloud of computers or servers.

Database(s) 340 can include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, IBM DB2 Database, and/or data warehouse system (e.g., Apache Hive).

In many embodiments, communication between system 310, front-end system 320, user device(s) 330, and/or database(s) 340 can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can determine an anchor product type for an anchor item. For example, an anchor item can be an item on an online retailer website (e.g., front-end system 320) that is currently displayed for or just added to the shopping cart by a consumer. An anchor product type can be cat food, baking mixes, or disinfectant cleaners, for instance. In a number of embodiments, system 310 further can determine at least one associated product type (e.g., a cross-pollination product type(s)) for the anchor product type, based on any suitable techniques (e.g., a predefined list of associated product types for each anchor product type, a semantic product type module, etc.).

In several embodiments, to determine the at least one associated product type for the anchor product type, system 310 further can determine at least one complementary product type for the anchor product type. The at least one complementary product type can be determined from a second product-type group (e.g., non-routine product types) that is different from a first product-type group (e.g., routine product types) comprising the anchor product type. In many embodiments, the first product-type group (e.g., the routine product types) can include product types that consumers repurchase on a periodic basis (e.g., food items, personal care products, household products, etc.), and non-routine product types can include product types that are not routine product types (e.g., items that can last longer, such as baking pans, cookware, electronics, etc.). By determining the at least one complementary product type from a different product-type group, system 310 can inspire consumers in the shopping journeys with an experience similar to in-store shopping.

In a number of embodiments, system 310 further can determine the at least one complementary product type based on a product-type-level association between the at least one complementary product type and anchor product type. In several embodiments, determining the at least one complementary product type for the anchor product type further can include determining at least one relevant complementary product type for the anchor product type. Determining the at least one complementary product type for the anchor product type further can include determining a respective product-type group for each of the at least one relevant complementary product type, via any suitable techniques (e.g., a manually defined table in database(s) 340 for the mapping between a product type and an associated product-type group, ML module 3110, a model based on decision trees or other machine learning techniques, an unsupervised clustering-based model, other statistical models based on co-purchase or co-viewed data distributions, semantic similarity models, etc.). In a few embodiments, system 310 further can determine the at least one complementary product type of the at least one relevant complementary product type based on the second product-type group and the respective product-type group, as determined. For instance, a product type of the at least one relevant complementary product type can be selected or determined as one of the at least one complementary product type when the product type is in the second product-type group (e.g., the non-routine product types).

In a number of embodiments, system 310 also can determine the at least one complementary product type for the anchor product type based at least in part on the historical transaction data and historical add-to-cart data associated with the anchor product type and the at least one complementary product type. For example, a product type of the at least one relevant complementary product type can be selected or determined as one of the at least one complementary product type when many or at least some items in the product type are frequently purchased or added to the shopping cart together with one or more items in the anchor product type.

In many embodiments, system 310 further can use a name-based semantic product type module to determine the at least one associated product type for the anchor product type based on the respective product-type names. In certain embodiments, a product-type name can include not only a name given to a product type but also the metadata associated with the product type. System 310 can include determining an anchor-product-type-name vector for an anchor-product-type name of the anchor product type, using any suitable natural language processing (NLP) techniques, such as using a tokenizer (e.g., the Natural Language ToolKit (NLTK), the spaCy library, Keras, etc.) and/or a text embedding modules (e.g., word2vec, BM25, TF-IDF, GloVe, doc2vec, Universal Sentence Encoder, BERT, etc.).

In many embodiments, before determining the anchor-product-type-name vector, system 310 further can: (a) train a product-type word encoder (e.g., word2vec, BM25, GloVe, etc.) to determine a respective word embedding for each word in a product-type name (e.g., the anchor product type, a respective complementary-product-type name of each of the at least one complementary product type, etc.) based on a training dataset; and (b) store the respective word embedding for each word, as determined by the product-type word encoder, in the database (e.g., database(s) 340) in order to save time for extracting word embeddings. In similar or different embodiments, determining the anchor-product-type-name vector further can include: (a) tokenizing the anchor-product-type name of the anchor product type for the anchor item, via any suitable tokenizers (e.g., NLTK tokenization, etc.); (b) retrieving, from a database (e.g., database(s) 340), one or more anchor word embeddings for the anchor-product-type name, as tokenized; and (c) aggregating the one or more anchor word embeddings into the anchor-product-type-name vector, via any suitable pooling functions (e.g., average pooling, max pooling, min pooling, etc.).

Further, in some embodiments, before training the product-type word encoder, system 310 can prepare the training dataset by: (a) determining one or more historical search words based on historical search queries; and (b) tokenizing, via any suitable tokenizers (e.g., NLTK tokenization), the one or more historical search words to be included in the training dataset.

Still referring to FIG. 3, system 310 further can determine a respective complementary-product-type-name vector for a respective complementary-product-type name of each of the at least one complementary product type. System 310 can determine the respective complementary-product-type-name vector using the tokenizer and/or the text embedding modules described above. In a number of embodiments, system 310 additionally can determine a respective product-type-name similarity score (e.g., cosine similarity, Euclidean distance, Jaccard Similarity, Word Mover's Distance, etc.) between the anchor-product-type-name vector and the respective complementary-product-type-name vector for each of the at least one complementary product type. Upon determining the respective product-type-name similarity score, system 310 can determine the at least one associated product type based at least in part on a product-type-level threshold (e.g., 0.3, 0.5, 0.7, 0.75, 0.8, etc.) and the respective product-type-name similarity score for each of the at least one complementary product type.

In a number of embodiments, once the at least one associated product type is determined, system 310 further can determine at least one associated item for the anchor item based at least in part on the at least one associated product type and at least one recommended item for the anchor item. The at least one recommended item can be determined based at least in part on historical transaction data associated with the anchor item, by any suitable item recommendation models or methods (e.g., pairwise logistic regression, collaborative filtering, a Noise-resistant complementary item recommendation system CIRS (NEAT) model, semantic item similarity, etc.). In a few embodiments, the at least one recommended item can include at least one substitute and/or complementary item determined based on an item recommendation module, such as NEAT.

In several embodiments, system 310 can select the at least one associated item when the at least one associated item is (a) among the at least one recommended item, determined as above, and (b) in a non-routine product type. That is, determining the at least one associated item for the anchor item further can include: (a) determining at least one complementary item of the at least one recommended item for the anchor item based at least in part on the historical transaction and browsing data (e.g., co-purchased items, co-viewed items, etc.); and (b) determining the at least one associated item from the at least one complementary item based at least in part on the at least one associated product type and a respective product type for each of the at least one associated item.

In some embodiments, system 310 additionally or alternatively can employ a name-based semantic item module for determining the at least one associated item. For example, determining the at least one associated item for the anchor item further can include: (a) determining an anchor-item-title vector for an anchor-item title of the anchor item, via any suitable text-based encoders (e.g., a Universal Sentence Encode (USE) model, word2vec, GloVe, BERT, doc2vec, etc.); (b) determining a respective associated-item-title vector for a respective associated-item title of each of the at least one associated item, via the text-based encoder(s) of (a); (c) determining a respective item-title similarity score between the anchor-item-title vector and the respective associated-item-title vector for each of the at least one associated item, via any suitable techniques (e.g., cosine similarity, Euclidean distance, etc.); and (d) removing, from the at least one associated item, each dissimilar item of the at least one associated item that is associated with the respective item-title similarity score below an item-level threshold (e.g., 0.4, 0.5, 0.6, 0.75, 0.87, etc.).

In a number of embodiments, system 310 further can rank the at least one associated item, as determined in one or more of the approaches described above, based at least in part on a respective similarity score and/or a respective popularity for each of the at least one associated item and the respective product-type-name similarity score for a respective product type for the each of the at least one associated item. The popularity for an item can be determined based on one or more factors, such as of the volume of purchases, the purchase rate, the add-to-cart rate, the product views, the price of the product, etc.

In some embodiments, system 310 further can set an upper limit for a total item quantity (e.g., 5, 10, 20, etc.) and/or a quantity per product type (e.g., 2, 3, or 5, etc.) for the at least one associated item. Limiting the quantity per product type can improve the diversity of the cross-pollination recommendations. Additional diversity enhancement measures can be used as well. For example, ranking the at least one associate item further can be based on the following rule: (a) ranking items of the at least one associate item based on the respective product-type-name similarity score with the anchor item; (b) ranking items within each product type based on the respective popularity; (c) splitting ties in (b), if any, based on the respective item-title similarity score with the anchor item; and (d) applying a round-robin diversification of an item per product type. This exemplary rule can be used for diversifying the at least one recommended item.

Moreover, in embodiments where the at least one associated item is determined based on more than one approaches, the at least one associated item as determined may include duplicates or closely related items. This issue also may apply to the at least one recommended item. For similar or different embodiments, system 310 further can de-duplicate the at least one associated item and/or the at least one recommended item. In several embodiments, de-duplicating additionally can include removing very similar or closely related items from the at least one associated item and/or the at least one recommended item. For example, when two items in the at least one associated item are closely related (e.g., with an item-level similarity score between the two items >0.8 or with an item-level similarity score >0.75, etc.), system 310 also can remove one of the two items, based on any suitable criteria or rules (e.g., removing the item with lower item-level similarity score with the anchor item, the item that is less popular, the item whose product type is relatively rarer in the at least one associated item, etc.).

In many embodiments, after the at least one associated item is determined, system 310 further can transmit, via a computer network (e.g., computer network 350), the at least one associated item to be displayed on a user interface for a user. In some embodiments, system 310 also can transmit the at least one recommended item, as determined, to be displayed on the user interface.

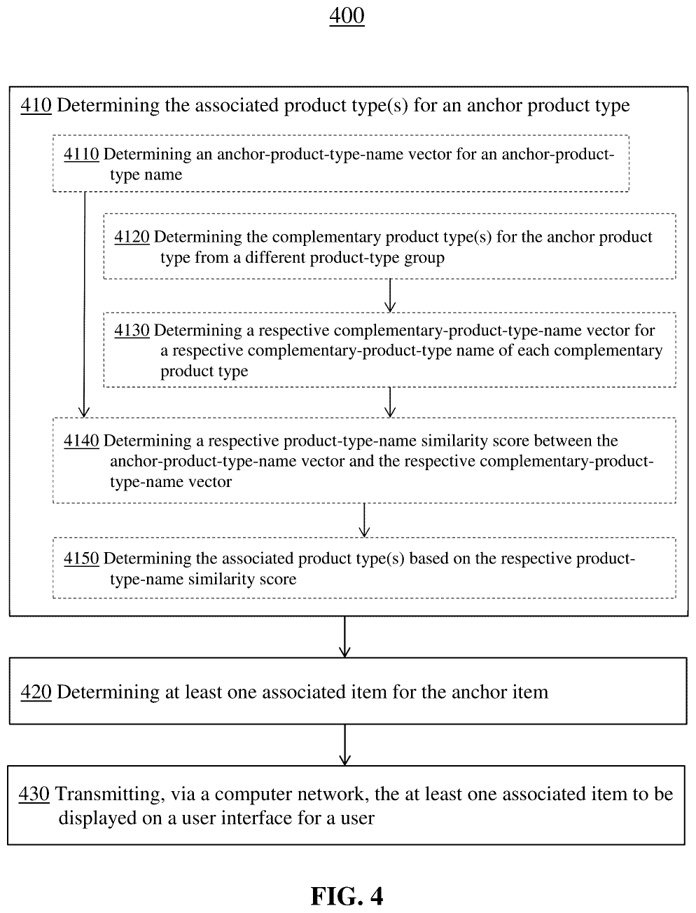

Turning ahead in the drawings, FIG. 4 illustrates a flow chart for a method 400 of providing cross-pollination recommendations, according to an embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3) or system 310 (FIG. 3) (including one or more of its elements, modules, and/or systems, such as ML module 3110 (FIG. 3)) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1).

Referring to FIG. 4, method 400 can be used for determining the cross-pollination recommendations for the anchor item based at least in part on one or more suitable product-type-level modules (e.g., a product-type-name semantic module) and/or item-level modules (e.g., an item-title semantic module). In many embodiments, method 400 can include an activity 410 of determining for the associated product type(s) for an anchor product type for an anchor item. In many embodiments, the anchor product type can belong to a first product-type group, and the associated product type(s) can belong to a second product-type group, which is different from the first product-type group. The first product-type group can include routine product types (e.g., food products, household goods, etc.), and the second product-type group can include non-routine product types (e.g., electronics, furniture, kitchen appliances, etc.). In some embodiments, the first product-type group and the second product-type group can be mutually exclusive. The anchor product type for the anchor item and the associated product type can be predefined.

In a number of embodiments, activity 410 further can include an activity 4110 of determining an anchor-product-type-name vector for an anchor-product-type name by one or more natural language processing (NLP) techniques (e.g., ML module 3110 (FIG. 3)), such as using a tokenizer (e.g., the NLTK (Natural Language ToolKit) tokenizer, the spaCy library, or Keras, etc.) and/or a product-type word encoder (e.g., word2vec, BM25, TF-IDF, GloVe, etc.). In some embodiments, method 400 or activity 410 further can include, before determining the anchor-product-type-name vector in activity 4110, training the product-type word encoder to determine a respective word embedding for each word, as tokenized by the tokenizer, of a product-type name based on a training dataset. In a few embodiments, the training dataset can include search words determined based on historical search queries and tokenized by the tokenizer.

In some embodiments, determining the anchor-product-type-name vector in activity 4110 further can include: (a) tokenizing the anchor-product-type name of the anchor product type for the anchor item, via a tokenizer; (b) encoding each tokenized word of the anchor-product-type name into a respective word embedding, via a product-type word encoder; and (c) aggregating the respective word embedding for each word of the anchor-product-type name into the anchor-product-type-name vector, via any suitable pooling functions (e.g., average pooling, max pooling, min pooling, etc.). In several embodiments, one or more time-consuming activities in activity 4110 can be modified or skipped to save time. For example, in certain embodiments, the respective word embedding, after being determined once by the product-type word encoder, can be stored in a database (e.g., database(s) 340 (FIG. 3)). In similar or different embodiments, activity 4110 further can include retrieving, instead of re-encoding, from the database (e.g., database(s) 340 (FIG. 3)), one or more anchor word embeddings for the words of the anchor-product-type name, if available.

In a number of embodiments, activity 410 additionally can include an activity 4120 of determining the complementary product type(s) for the anchor product type from a different product-type group (e.g., the second product-type group) from the product-type group for the anchor product type (e.g., the first product-type group). If the complementary product type(s) includes more than one complementary product types for the anchor product type, each of the more than one complementary product types can be from the second product-type group.

In several embodiments, the complementary product type(s) for the anchor product type can be determined in activity 4120 by: (a) determining at least one relevant complementary product type for the anchor product type based at least in part on the co-purchase and/or co-add-to-cart history between items from the anchor product type and the at least one relevant complementary product type; (b) determining a respective product-type group for each of the at least one relevant complementary product type, via any suitable techniques (e.g., a pre-trained decision tree-based machine learning model, ML module 3110 (FIG. 3), etc.); and (c) determining that a relevant product type of the at least one relevant complementary product type is included in the complementary product type(s) when the respective product-type group for the relevant product type, as determined in (b), is the second product-type group.

In a number of embodiments, activity 410 further can include an activity 4130 of determining a respective complementary-product-type-name vector for a respective complementary-product-type name of each complementary product type, using the techniques described above. In several embodiments, activity 410 also can include an activity 4140 of determining a respective product-type-name similarity score between the anchor-product-type-name vector, determined in activity 4110, and the respective complementary-product-type-name vector, determined in activity 4130. The respective product-type-name similarity score between the anchor-product-type-name vector and the respective complementary-product-type-name vector can be determined based on any suitable approaches (e.g., cosine similarity or Euclidean distance).

In several embodiments, activity 410 further can include an activity 4150 of determining the at least one associated product type(s) based on the respective product-type-name similarity score for each complementary product type. For example, when the respective product-type-name similarity score between a complementary product type and the anchor product type is no less than a product-type-level threshold (e.g., 0.5, 0.6, 0.7, etc.), activity 4150 can determine that the at associated product type(s) includes the complementary product type.

In many embodiments, method 400 further can include an activity 420 of determining at least one associated item for the anchor item based on any suitable techniques, such as an item recommendation module as described above, and/or an item-title semantic module as described above. The item recommendation module can provide recommendations for items that are similar to or complementary with the anchor item. In a few embodiments, using the item-title semantic module in activity 420 for determining the at least one associated item further can include: (a) determining an anchor-item-title vector for an anchor-item title of the anchor item, via a USE (Universal Sentence Encode) text encoder; (b) determining a respective associated-item-title vector for a respective associated-item title of each of the at least one associated item, via the USE text encoder; (c) determining a respective item-title similarity score by calculating the cosine similarity between the anchor-item-title vector and the respective associated-item-title vector for each of the at least one associated item; and/or (d) removing, from the at least one associated item, each of the at least one associated item associated with the respective item-title similarity score below an item-level threshold (e.g., 0.4, 0.5, 0.65, etc.).

In several embodiments, method 400 further can include one or more additional activities or techniques described above, such as ranking, diversifying, de-duplicating, etc. In some embodiments, method 400 further can include an activity 430 of transmitting, via a computer network (e.g., computer network 350 (FIG. 3)), the at least one associated item to be displayed on a user interface (e.g., user device(s) 330 (FIG. 3)) for a user.

Various embodiments can include a system for providing cross-pollination recommendations. The system can include one or more processors and one or more non-transitory computer-readable media storing computing instructions that, when executed on the one or more processors, cause the one or more processors to perform certain operations. The operations can include determining an anchor product type for an anchor item. The operations further can include determining at least one associated product type for the anchor product type. Determining the at least one associated product type for the anchor product type further can include: (a) determining at least one complementary product type for the anchor product type, wherein the at least one complementary product type can be determined from a second product-type group that is different from a first product-type group comprising the anchor product type; (b) determining an anchor-product-type-name vector for an anchor-product-type name of the anchor product type; (c) determining a respective complementary-product-type-name vector for a respective complementary-product-type name of each of the at least one complementary product type; (d) determining a respective product-type-name similarity score between the anchor-product-type-name vector and the respective complementary-product-type-name vector for each of the at least one complementary product type; and (e) determining the at least one associated product type based at least in part on a product-type-level threshold and the respective product-type-name similarity score for each of the at least one complementary product type. The operations also can include determining at least one associated item for the anchor item based at least in part on the at least one associated product type and at least one recommended item for the anchor item, wherein the at least one recommended item is determined based at least in part on historical transaction data associated with the anchor item. The operations further can include transmitting, via a computer network, the at least one associated item to be displayed on a user interface for a user.

A number of embodiments can include a computer-implemented method. The method can include determining an anchor product type for an anchor item. The method further can include determining at least one associated product type for the anchor product type. Determining the at least one associated product type for the anchor product type further can include: (a) determining at least one complementary product type for the anchor product type, wherein the at least one complementary product type can be determined from a second product-type group that is different from a first product-type group comprising the anchor product type; (b) determining an anchor-product-type-name vector for an anchor-product-type name of the anchor product type; (c) determining a respective complementary-product-type-name vector for a respective complementary-product-type name of each of the at least one complementary product type; (d) determining a respective product-type-name similarity score between the anchor-product-type-name vector and the respective complementary-product-type-name vector for each of the at least one complementary product type; and (e) determining the at least one associated product type based at least in part on a product-type-level threshold and the respective product-type-name similarity score for each of the at least one complementary product type. The method also can include determining at least one associated item for the anchor item based at least in part on the at least one associated product type and at least one recommended item for the anchor item. The at least one recommended item can be determined based at least in part on historical transaction data associated with the anchor item. The method further can include transmitting, via a computer network, the at least one associated item to be displayed on a user interface for a user.

In many embodiments, the techniques described herein can provide a practical application and several technological improvements. The techniques described herein can provide various machine learning modules, including name-based semantic modules trained to determine similarities between product type names or item titles, a word encoder trained to generate a word embedding, a text encoder trained to generate a text embedding, and/or a decision tree-based machine learning module trained to determine a product type group for a product type. These techniques described herein can provide a significant improvement over conventional approaches that determine similarities between items generally based on transaction history by further taking into account the relationships between product types, using the pre-trained machine learning modules. Further, the name-based semantic modules, as an example, provide simplified techniques for determining product-type-level and/or item-level similarities.

Although providing cross-pollination recommendations has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-4 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders. As another example, the modules, elements, and/or systems within system 300 or system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising one or more processors and one or more non-transitory computer-readable media storing computing instructions that, when executed on the one or more processors, cause the one or more processors to perform operations comprising:
determining an anchor product type for an anchor item;
determining at least one associated product type for the anchor product type, comprising:
determining at least one complementary product type for the anchor product type, wherein the at least one complementary product type is determined from a second product-type group that is different from a first product-type group comprising the anchor product type;
determining an anchor-product-type-name vector for an anchor-product-type name of the anchor product type;
determining a respective complementary-product-type-name vector for a respective complementary-product-type name of each of the at least one complementary product type;
determining a respective product-type-name similarity score between the anchor-product-type-name vector and the respective complementary-product-type-name vector for each of the at least one complementary product type; and
determining the at least one associated product type based at least in part on a product-type-level threshold and the respective product-type-name similarity score for each of the at least one complementary product type;
determining at least one associated item for the anchor item based at least in part on the at least one associated product type and at least one recommended item for the anchor item, wherein the at least one recommended item is determined based at least in part on historical transaction data associated with the anchor item; and
transmitting, via a computer network, the at least one associated item to be displayed on a user interface for a user.

2. The system of claim 1, wherein determining the at least one complementary product type for the anchor product type further comprises:
determining at least one relevant complementary product type for the anchor product type;
determining a respective product-type group for each of the at least one relevant complementary product type; and
determining the at least one complementary product type of the at least one relevant complementary product type based on the second product-type group and the respective product-type group, as determined.

3. The system of claim 1, wherein:
determining the at least one complementary product type for the anchor product type is further based at least in part on the historical transaction data and historical add-to-cart data associated with the anchor product type and the at least one complementary product type.

4. The system of claim 1, wherein:
determining the anchor-product-type-name vector further comprises:
tokenizing the anchor-product-type name of the anchor product type for the anchor item;
retrieving, from a database, one or more anchor word embeddings for the anchor-product-type name, as tokenized; and
aggregating the one or more anchor word embeddings into the anchor-product-type-name vector.

5. The system of claim 4, wherein the operations further comprise:
before determining the anchor-product-type-name vector, training a product-type word encoder to determine a respective word embedding for each word in a product-type name based on a training dataset; and
storing the respective word embedding for each word, as determined by the product-type word encoder, in the database.

6. The system of claim 5, wherein the operations further comprise:
before training the product-type word encoder, preparing the training dataset by:
determining one or more historical search words based on historical search queries; and
tokenizing the one or more historical search words to be included in the training dataset.

7. The system of claim 1, wherein determining the at least one associated item for the anchor item further comprises:
determining at least one complementary item of the at least one recommended item for the anchor item based at least in part on the historical transaction data; and
determining the at least one associated item from the at least one complementary item based at least in part on the at least one associated product type and a respective product type for each of the at least one associated item.

8. The system of claim 7, wherein determining the at least one associated item for the anchor item further comprises:
determining an anchor-item-title vector for an anchor-item title of the anchor item;
determining a respective associated-item-title vector for a respective associated-item title of each of the at least one associated item;
determining a respective item-title similarity score between the anchor-item-title vector and the respective associated-item-title vector for each of the at least one associated item; and
removing, from the at least one associated item, each dissimilar item of the at least one associated item that is associated with the respective item-title similarity score below an item-level threshold.

9. The system of claim 8, wherein:
determining the anchor-item-title vector further comprises:
using a text-based encoder to generate the anchor-item-title vector for the anchor-item title of the anchor item.

10. The system of claim 1, wherein the operations further comprise, after determining the at least one associated item for the anchor item, one or more of:
ranking the at least one associated item, as determined, based at least in part on a respective popularity for each of the at least one associated item and the respective product-type-name similarity score for a respective product type for the each of the at least one associated item;
de-duplicating the at least one associated item and the at least one recommended item, wherein transmitting the at least one associated item to be displayed on the user interface further comprises transmitting the at least one recommended item, as de-duplicated, to be displayed on the user interface; or
diversifying the at least one associate item by:
ranking the at least one associate item based on the respective product-type-name similarity score with the anchor item to group the at least one associate item based on the respective product type;
ranking the at least one associate item within each product type based on the respective popularity for each of the at least one associated item;
when a tie exists between two or more grouped items of the at least one associate item in a product type, splitting the tie by ranking the two or more grouped items based on a respective item-title similarity score between the anchor item and each of the two or more grouped items; and
applying a round-robin diversification by alternatively selecting an item of the at least one associate item, as grouped and ranked, based on the respective product type and a respective ranking in the respective product type.

11. A computer-implemented method comprising:
determining an anchor product type for an anchor item;
determining at least one associated product type for the anchor product type, comprising:
determining at least one complementary product type for the anchor product type, wherein the at least one complementary product type is determined from a second product-type group that is different from a first product-type group comprising the anchor product type;
determining an anchor-product-type-name vector for an anchor-product-type name of the anchor product type;
determining a respective complementary-product-type-name vector for a respective complementary-product-type name of each of the at least one complementary product type;
determining a respective product-type-name similarity score between the anchor-product-type-name vector and the respective complementary-product-type-name vector for each of the at least one complementary product type; and
determining the at least one associated product type based at least in part on a product-type-level threshold and the respective product-type-name similarity score for each of the at least one complementary product type;
determining at least one associated item for the anchor item based at least in part on the at least one associated product type and at least one recommended item for the anchor item, wherein the at least one recommended item is determined based at least in part on historical transaction data associated with the anchor item; and
transmitting, via a computer network, the at least one associated item to be displayed on a user interface for a user.

12. The computer-implemented method of claim 11, wherein determining the at least one complementary product type for the anchor product type further comprises:
determining at least one relevant complementary product type for the anchor product type;
determining a respective product-type group for each of the at least one relevant complementary product type; and
determining the at least one complementary product type of the at least one relevant complementary product type based on the second product-type group and the respective product-type group, as determined.

13. The computer-implemented method of claim 11, wherein:
determining the at least one complementary product type for the anchor product type is further based at least in part on the historical transaction data and historical add-to-cart data associated with the anchor product type and the at least one complementary product type.

14. The computer-implemented method of claim 11, wherein:
determining the anchor-product-type-name vector further comprises:
tokenizing the anchor-product-type name of the anchor product type for the anchor item;
retrieving, from a database, one or more anchor word embeddings for the anchor-product-type name, as tokenized; and
aggregating the one or more anchor word embeddings into the anchor-product-type-name vector.

15. The computer-implemented method of claim 14 further comprising:
before determining the anchor-product-type-name vector, training a product-type word encoder to determine a respective word embedding for each word in a product-type name based on a training dataset; and
storing the respective word embedding for each word, as determined by the product-type word encoder, in the database.

16. The computer-implemented method of claim 15 further comprising:
before training the product-type word encoder, preparing the training dataset by:
determining one or more historical search words based on historical search queries; and
tokenizing the one or more historical search words to be included in the training dataset.

17. The computer-implemented method of claim 11, wherein determining the at least one associated item for the anchor item further comprises:
determining at least one complementary item of the at least one recommended item for the anchor item based at least in part on the historical transaction data; and
determining the at least one associated item from the at least one complementary item based at least in part on the at least one associated product type and a respective product type for each of the at least one associated item.

18. The computer-implemented method of claim 17, wherein determining the at least one associated item for the anchor item further comprises:
determining an anchor-item-title vector for an anchor-item title of the anchor item;
determining a respective associated-item-title vector for a respective associated-item title of each of the at least one associated item;
determining a respective item-title similarity score between the anchor-item-title vector and the respective associated-item-title vector for each of the at least one associated item; and
removing, from the at least one associated item, each dissimilar item of the at least one associated item that is associated with the respective item-title similarity score below an item-level threshold.

19. The computer-implemented method of claim 18, wherein:
determining the anchor-item-title vector further comprises:
using a text-based encoder to generate the anchor-item-title vector for the anchor-item title of the anchor item.

20. The computer-implemented method of claim 11 further comprising, after determining the at least one associated item for the anchor item, one or more of:
ranking the at least one associated item, as determined, based at least in part on a respective popularity for each of the at least one associated item and the respective product-type-name similarity score for a respective product type for the each of the at least one associated item;
de-duplicating the at least one associated item and the at least one recommended item, wherein transmitting the at least one associated item to be displayed on the user interface further comprises transmitting the at least one recommended item, as de-duplicated, to be displayed on the user interface; or diversifying the at least one associate item by:
ranking the at least one associate item based on the respective product-type-name similarity score with the anchor item to group the at least one associate item based on the respective product type;
ranking the at least one associate item within each product type based on the respective popularity for each of the at least one associated item;
when a tie exists between two or more grouped items of the at least one associate item in a product type, splitting the tie by ranking the two or more grouped items based on a respective item-title similarity score between the anchor item and each of the two or more grouped items; and
applying a round-robin diversification by alternatively selecting an item of the at least one associate item, as grouped and ranked, based on the respective product type and a respective ranking in the respective product type.
